(19) United States
(12) Patent Application Publication
(10) Pub. No.: US 2015/0174521 A1
(43) Pub. Date: Jun. 25, 2015

(54) METHOD OF OPERATING A GAS SCRUB AND GAS SCRUB

(71) Applicant: LINDE AKTIENGESELLSCHAFT, Muenchen (DE)

(72) Inventors: Ulvi KERESTECIOGLU, Geltendorf (DE); Werner MAYER, Ichenhausen (DE)

(73) Assignee: LINDE AKTIENGESELLSCHAFT, Muenchen (DE)

(21) Appl. No.: 14/580,957

(22) Filed: Dec. 23, 2014

(30) Foreign Application Priority Data
Dec. 23, 2013 (DE) 102013022083.1

(51) Int. Cl. B01D 53/14

(52) U.S. Cl. CPC B01D 53/1425; B01D 53/1493; B01D 53/1456; B01D 2252/2021; B01D 2252/204

(57) ABSTRACT

The invention relates to a method of shutting down at least part of a gas scrub (G), and to a gas scrub (G) which comprises an absorber (A) and a regeneration part (R). In normal operation a scrubbing medium (1) is circulated in a scrubbing medium circuit and thus loaded in the absorber (A) at elevated pressure with substances removed from a gas mixture. The substances are removed from the loaded scrubbing medium (2) in the regeneration part (R). Scrubbing medium (3) is removed from the scrubbing medium circuit, transferred into a storage tank (S) and stored there at atmospheric pressure. Loaded scrubbing medium (3) is warmed (E1) and intermediately stored at elevated pressure in a degassing vessel (Z) in order to remove absorbed substances (5) from the scrubbing medium before it is passed into the storage tank (S).

The invention relates to a method of shutting down at least part of a gas scrubbing operation which comprises an absorber and a regeneration part. In normal operation a scrubbing medium is circulated in a scrubbing medium circuit and thus loaded in the absorber at elevated pressure with substances removed from a gas mixture. These substances are removed from the loaded scrubbing medium in the regeneration part. In the inventive method, scrubbing medium is removed from the scrubbing medium circuit, transferred into a storage tank and stored there at atmospheric pressure.

The invention further relates to an apparatus for carrying out the method according to the invention.

Gas scrubs have been used for many years for the industrial scale separation of gas mixtures. A gas scrub is a continuous process wherein the gas mixture to be separated is, in this case, contacted with a scrubbing medium at elevated pressure in an absorber. The scrubbing medium dissolves the different components of the gas mixture to varying extents, so that the gas stream exiting the absorber has been freed of one or more of its original constituents at least to some extent. The scrubbing medium loaded with the components removed from the gas mixture is drawn off from the absorber and supplied to a regeneration part in order to regenerate the scrubbing medium by removing the gas components before it is once again recycled to the absorber and used for gas scrubs. The scrubbing medium thus circulates in a scrubbing medium circuit during normal operation of the gas scrub.

Examples of such gas scrubs include methanol and amine scrubs used in industry to remove acidic gases from crude synthesis gases to obtain synthesis gases containing predominantly hydrogen and carbon monoxide.

In case of planned shutdown of a gas scrub, the feed to the absorber of the gas mixture to be separated is interrupted while the scrubbing medium continues to be circulated in the scrubbing medium circuit for a time in order for the scrubbing medium to be completely regenerated. The scrubbing medium freed of removed gas components is subsequently removed from the scrubbing medium circuit, decompressed to atmospheric pressure and passed into a storage tank from which it may be removed again for further operation of the gas scrub.

When unplanned shutdown of a gas scrub is necessary, for example due to a malfunction, or only part of a gas scrub is to be deactivated, it is not always possible to completely regenerate the scrubbing medium to be discharged from the scrubbing medium circuit and thus in certain circumstances scrubbing medium loaded with removed gas components needs to be passed into the storage tank where the gas components outgas due to the pressure drop. This effect is moreover amplified when the temperature of the scrubbing medium in the storage tank increases, for example due to solar irradiation. Since the outgassing components may be toxic substances, for example hydrogen sulphide or hydrocyanic acid, which may not readily be released to the environment, it is necessary for the storage tank to be connected to a flare which is generally operated at a low pressure of from 1.5 to 3 bar. A storage tank would thus need to be configured as a pressure vessel in order for it to be operable safely under the conditions described. However due to its large volume, which may be several thousand cubic meters in the case of a methanol scrub, economic factors dictate that the storage tank is normally an unpressurized vessel. As a result, the prior art seeks to suppress outgassing by first introducing unloaded scrubbing medium to the storage tank prior to introduction of loaded scrubbing medium. However, such a procedure is not always possible, particularly when only part of the gas scrub is to be deactivated.

It is thus an object of the present invention to provide a method and an apparatus of the type described above which overcomes the prior art disadvantages described.

Upon further study of the specification and appended claims, other objects, aspects and advantages of the invention will become apparent.

In method terms, these objects are achieved in accordance with the invention by a method wherein loaded scrubbing medium is warmed and intermediately stored at elevated pressure in a degassing vessel, in order to remove absorbed substances from the scrubbing medium before it is passed into the storage tank.

Further embodiments of the method according to the invention provide that:
the loaded scrubbing medium is warmed before it is introduced into the degassing vessel and/or is warmed in the degassing vessel; and/or
substances removed from the loaded scrubbing medium are drawn off from the degassing vessel and supplied to a flare for disposal.

The regeneration part of a gas scrub generally comprises what is known as a hot regeneration wherein gaseous components present in the loaded scrubbing medium are desorbed at low pressure by warming. When the hot regeneration is unaffected by the shutdown, substances removed from the loaded scrubbing medium in the degassing vessel may also be introduced to the hot regeneration to recover any scrubbing media present.

The material stream supplied to the flare may preferably be subjected to a water scrub downstream of the degassing vessel in order to scrub out and recover residual scrubbing medium before the material stream is disposed of in the flare.

Further embodiments of the method according to the invention provide that:
the scrubbing medium treated in the degassing vessel is cooled down while being passed to the storage tank; and/or
the scrubbing medium is methanol or an amine solution which is loaded with acidic gases such as carbon dioxide and/or hydrogen sulphide during gas scrubbing.

A gas scrub generally comprises a vessel for low point draining, known as a slop drum, which is disposed at the lowest point of the plant and which on shutdown of the gas scrub serves to receive residual scrubbing medium draining out of the scrubbing medium circuit merely under gravity once all pumps have been deactivated. A slop drum has a substantially smaller volume than a storage tank but is generally configured as a pressure vessel and connected to the flare. A particularly preferred embodiment of the method according to the invention thus provides that the slop drum of the gas scrub is used as the degassing vessel.

The invention further relates to an apparatus for carrying out a gas scrub comprising an absorber and a regeneration part as part of a scrubbing medium circuit in which a scrubbing agent may be circulated and thus loaded in the absorber at elevated pressure with substances removed from a gas mixture. The substances are removable from the loaded scrubbing medium in the regeneration part. The apparatus further comprises a storage tank hydrodynamically connectable to the scrubbing medium circuit into which tank scrubbing medium from the scrubbing medium circuit may be transferred in order to be stored there at atmospheric pressure.

In apparatus terms, the stated objects are achieved in accordance with the invention by an apparatus comprising a warming apparatus and a degassing vessel configured as a pressure vessel which is hydrodynamically connectable to both the scrubbing medium circuit and the storage tank, so that loaded scrubbing medium may be warmed and intermediately stored at elevated pressure in the degassing vessel in order to remove absorbed substances from the scrubbing medium before it is passed into the storage tank.

Further embodiments of the apparatus according to the invention provide that:
the loaded scrubbing medium is warmed before it is introduced into the degassing vessel and/or is warmed in the degassing vessel; and/or
the warming means (e.g., a heat exchanger) is arranged upstream of and/or inside the degassing vessel; and/or
the degassing vessel is connectable to a flare, so that substances removed from the loaded scrubbing medium may be drawn off from the degassing vessel and supplied to a flare for disposal.

When the regeneration part of the gas scrub comprises a hot regeneration the degassing vessel may alternatively or additionally be connectable to the hot regeneration, so that substances removed from the loaded scrubbing medium may be drawn off from the degassing vessel and introduced into the hot regeneration.

Downstream of the degassing vessel and upstream of the flare there is preferably disposed a scrubbing means configured as a water scrub in which residual scrubbing medium may be scrubbed out of the stream of removed substances.

Further embodiments of the apparatus according to the invention provide that:
upstream of the storage tank and inside and/or downstream of the degassing vessel there is disposed a cooling means (e.g., a heat exchanger) preferably operated with water as cooling medium in which scrubbing medium drawn off from the degassing vessel may be cooled down before being introduced into the storage tank; and/or
the degassing vessel is a slop drum; and/or
said apparatus is configured as a methanol or amine scrub in which acidic gases may be scrubbed out of a gas mixture using cryogenic methanol or an amine solution.

### BRIEF DESCRIPTION OF THE DRAWINGS

Further details and advantages of the invention will be illustrated by the description hereinafter of an exemplary embodiment shown in the figure, wherein:

FIG. 1 illustrates a working example of the invention.

FIG. 1 shows a gas scrub where, when the scrub is shut down completely or partially, scrubbing medium may be removed from the scrubbing medium circuit in the loaded state and stored at atmospheric pressure in a storage tank.

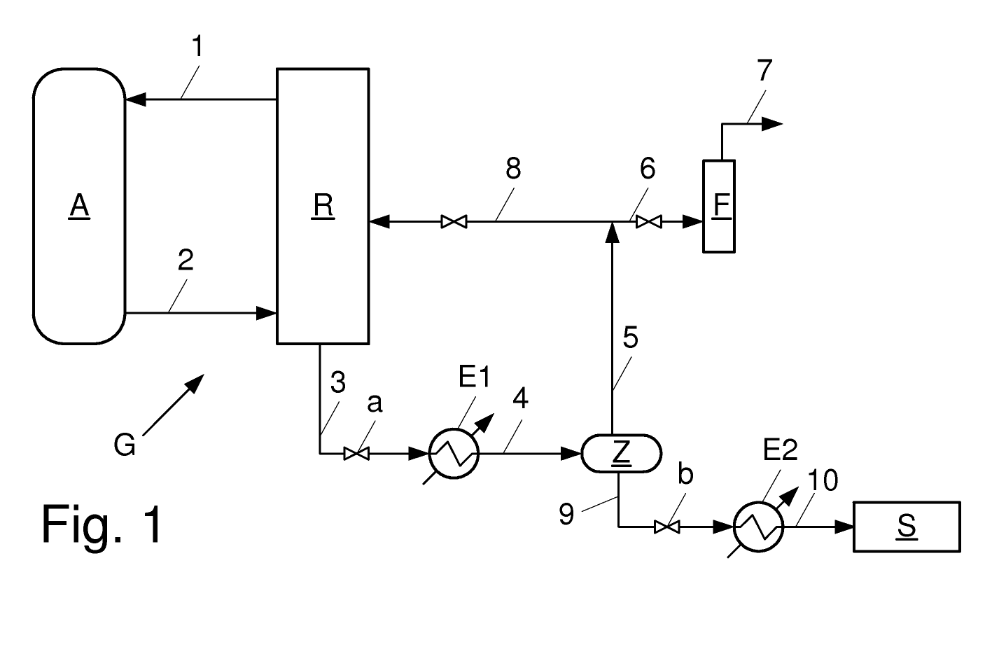

In normal operation, gas scrub G comprises a scrubbing medium circulating in a scrubbing medium circuit and scrubbing medium in the unloaded state may therefore be introduced into absorber A to separate a gas mixture, scrubbing medium 2 loaded with removed gas components being drawn off from the absorber A. The loaded scrubbing medium is regenerated in regeneration part R to obtain unloaded scrubbing medium 1 which is reused in the absorber. The typical operating pressure for the absorber depends on the type of scrubbing medium used. In the case of a physical scrubbing medium, the absorber can be operated at pressures between 15 and 150 bar(a). If the scrubbing medium is a chemical medium (e.g. an amine), the operating pressure of the absorber can be up to 5 bar(a).

In case of complete or partial shutdown of the gas scrub G, scrubbing medium 3 may be drawn off in the loaded state from the scrubbing medium circuit and decompressed via throttling element a to a pressure which is slightly higher than the low pressure of flare F which is typically operated at a pressure of between 1.5 and 3 bar. The loaded scrubbing medium is warmed in heat exchanger E1 before it is introduced via line 4 into depressurization vessel Z which is configured as a pressure vessel and which is preferably the slop drum of gas scrub G. A gas phase 5 composed of substances that were dissolved in the loaded scrubbing medium 3 is formed here and passed via line 6 to the flare F to be incinerated there, so that an offgas 7 complying with statutory regulations may be released to the environment. The gas phase from the depressurization (degassing) vessel Z may alternatively be recycled via line 8 into the hot regeneration (not shown) of the regeneration part R in order to recover any scrubbing medium present in the gas phase. Substantially unloaded scrubbing medium is discharged from the depressurization vessel Z via line 9, decompressed to atmospheric pressure via the throttling element b and cooled in heat exchanger E2 before it is introduced via line 10 into storage tank S from which it may be removed again later for normal operation of the gas scrub G.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

The entire disclosures of all applications, patents and publications, cited herein and of corresponding German patent application DE 10 201 3 022 083.1, filed Dec. 23, 2013, are incorporated by reference herein.

1. A method of shutting down at least part of a gas scrub which comprises an absorber and a regeneration part,
wherein in normal operation a scrubbing medium is circulated in a scrubbing medium circuit and said scrubbing medium becomes loaded in the absorber at elevated pressure with substances removed from a gas mixture, and
said substances are removed from the loaded scrubbing medium again in the regeneration part, said method comprising:
removing loaded scrubbing medium from the scrubbing medium circuit,
transferring the removed loaded scrubbing medium into a storage tank and storing the removed scrubbing medium therein at atmospheric pressure, and
before being passed into said storage tank, the removed loaded scrubbing medium is warmed and intermediately stored at elevated pressure in a degassing vessel in order to remove absorbed substances from the removed loaded scrubbing medium.

2. The method according to claim 1, wherein the loaded scrubbing medium is warmed before it is introduced into the degassing vessel.

3. The method according to claim 1, wherein the loaded scrubbing medium is warmed is warmed in the degassing vessel.

4. The method according to claim 3, wherein the loaded scrubbing medium is warmed is warmed in the degassing vessel.

5. The method according to claim 1, wherein substances removed from the loaded scrubbing medium are drawn off from the degassing vessel and supplied to a flare for disposal and/or to a hot regeneration disposed in the regeneration part of the gas scrub.

6. The method according to claim 1, wherein, the scrubbing medium treated in the degassing vessel is cooled down while being passed to the storage tank.

7. The method according to claim 1, wherein substances removed from the loaded scrubbing medium are drawn off from the degassing vessel as a material stream and supplied to a flare for disposal, and
said material stream comprising substances removed from the loaded scrubbing medium is subjected to a scrub, preferably carried out with water downstream of the degassing vessel in order to scrub out residual scrubbing medium, before the material stream is disposed of in the flare.

8. The method according to claim 1, wherein the loaded scrubbing medium is methanol or an amine solution which is loaded with acidic gases, such as carbon dioxide and/or hydrogen sulphide, during gas scrubbing.

9. The method according to claim 1, wherein a slop drum of the gas scrub is used as said degassing vessel.

10. An apparatus for carrying out a gas scrub comprising:
an absorber and a regeneration part as part of a scrubbing medium circuit in which a scrubbing agent may be circulated and thus loaded in the absorber at elevated pressure with substances removed from a gas mixture, the substances being removable from the loaded scrubbing medium again in the regeneration part, and
a storage tank hydrodynamically connectable to the scrubbing medium circuit into which storage tank scrubbing medium from the scrubbing medium circuit may be transferred in order to be stored there at atmospheric pressure,
said apparatus further comprising a warming means and a degassing vessel configured as a pressure vessel which is hydrodynamically connectable to both said scrubbing medium circuit and said storage tank, so that loaded scrubbing medium may be warmed and intermediately stored at elevated pressure in said degassing vessel in order to remove absorbed substances from the scrubbing medium before the scrubbing medium is passed into said storage tank.

11. The apparatus according to claim 10, wherein said warming means is arranged upstream of and/or inside said degassing vessel.

12. The apparatus according to claim 10, wherein said degassing vessel is connectable to a flare and/or said regeneration part, so that substances removed from the loaded scrubbing medium may be drawn off from said degassing vessel and supplied to said flare for disposal and/or to a hot regeneration disposed in said regeneration part of said gas scrub.

13. The apparatus according to claim 10, wherein, upstream of said storage tank and inside and/or downstream of said degassing vessel a cooling means is disposed, preferably operated with water as cooling medium, in which scrubbing medium drawn off from said degassing vessel may be cooled down before being introduced into said storage tank.

14. The apparatus according to claim 12, wherein, downstream of said degassing vessel and upstream of said flare, a scrubbing means is disposed, preferably configured as a water scrub, in which residual scrubbing medium may be scrubbed out of the stream of removed substances.

15. (The apparatus according to claim 13, wherein, downstream of said degassing vessel and upstream of said flare, a scrubbing means is disposed, preferably configured as a water scrub, in which residual scrubbing medium may be scrubbed out of the stream of removed substances.

16. The apparatus according to claim 10, wherein said degassing vessel is a slop drum.

17. The apparatus according to claim 10, wherein said apparatus is configured as a methanol or amine scrub in which acidic gases may be scrubbed out of a gas mixture using cryogenic methanol or an amine solution.
